(19) United States
(12) Patent Application Publication
(10) Pub. No.: US 2003/0006514 A1
(43) Pub. Date: Jan. 9, 2003

(54) Molding method and molding die for vehicular lamp lens

(75) Inventors: Mamoru Kosuge, Shizuoka (JP); Makoto Sano, Shizuoka (JP); Masaru Takiguchi, Shizuoka (JP)

Correspondence Address: SUGHRUE MION, PLLC, 2100 Pennsylvania Avenue, NW, Washington, DC, 20037-3213, US

(73) Assignee: KOITO MANUFACTURING CO., LTD.

(21) Appl. No.: 10/184,066

(22) Filed: Jun. 28, 2002

(30) Foreign Application Priority Data
Jul. 2, 2001 (JP) P.2001-200544

(51) Int. Cl. B29D 11/00; B29C 33/60

(52) U.S. Cl. 264/1.1; 264/338; 249/111; 425/573; 425/577

(57) ABSTRACT

A molding method and a molding die for producing a lens of a vehicular lamp wherein the lens has an improved appearance in that no weld lines are formed on the surface of the lens and the lens consequently has an improved mechanical strength. The molding die has a gathering area for molten resin in the molding cavity in a flow region of the molten resin to be formed into a lens. A heat insulating layer is formed on a cavity face on the side of the lens surface at the gathering area for the molten resin in the molding die, as a result of which instantaneous cooling is prevented. Accordingly, a skin layer formed on the side of the lens surface at the gathering area is very thin, thereby preventing the generation of a weld line, which could otherwise be generated if thick skin layers produced when high-temperature molten resin directly comes into contact with steel material and cooled instantaneously are gathered together.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

The present invention relates to a molding method and a molding die for a lens of a vehicular lamp. More particularly, the present invention relates to such a molding method and molding die which results in an improvement in the appearance and strength of the lens.

A lens of a vehicular lamp is usually formed by injection molding of a thermoplastic resin. With such a process, a lens of a vehicular lamp is provided which is excellent in transparency and shape reproducibility and which is light and inexpensive.

However, a weld line is generated on the surface of the lens because of the injection molding of thermoplastic resin, so that there is a problem that the appearance of the lamp may be disturbed. Further, because the weld line is a fine stripe-like groove, the mechanical strength of the lens is reduced at the location of the weld line.

Generally, it is known that the weld line in a resin molded product is generated at a gathering area for flows of molten resin injected into a die cavity. For example, as shown in FIG. 4, in the case of a lens a formed with a collection die for a multi-color molded lens, since there are opening portions b, c formed to which other color lenses are later fitted, and an island-like block for forming the opening portions b, c is located in the cavity, the flow patterns of the molten resin are complicated, thereby generating multiple weld lines d. The positions in which the weld lines d are generated and the lengths thereof are determined depending on the quantity and positions of the injection gates e as well as the shape of the lens a. FIG. 4 shows the approximate positions of the injection gates e in the case where two gates are provided.

### BRIEF SUMMARY OF THE INVENTION

Accordingly, objects of the present invention is to improve appearance of a lens by eliminating the generation of weld lines on the surface of the lens and to further improve the mechanical strength of the lens.

To solve the above-described problem, a manufacturing method for a lens of a vehicular lamp according to the present invention comprises the steps of injecting molten resin into a cavity in a die and cooling the molten resin in the cavity, wherein a heat insulating layer is formed on a cavity face on a side of lens surface at a gathering area for the molten resin in the die.

Thus, in the manufacturing method for a lens of a vehicular lamp according to the present invention, the molten resin injected into the cavity comes into contact with the heat insulating layer on the side of the lens surface at the gathering area. Thus, instantaneous cooling is prevented, so that a skin layer formed on the side of the lens surface at the gathering area is very thin, thereby preventing the generation of a weld line, which could otherwise be generated if thick skin layers produced when high-temperature molten resin directly comes into contact with steel material and cooled instantaneously are gathered together. Accordingly, the appearance of the lens surface is improved, and the mechanical strength at the gathering area is also improved.

Further, to solve the above-described problem, a molding die for a lens of a vehicular lamp according to the present invention includes a gathering area for molten resin which is injected into a cavity and which is to be molded into the lens, wherein a heat insulating layer is formed on a cavity face on a side of lens surface at the gathering area.

Thus, in the molding die for a lens of a vehicular lamp according to the present invention, the molten resin injected into the cavity comes into contact with the heat insulating layer on the side of the lens surface at the gathering area for the molten resin. Thus, instantaneous cooling is prevented so that a skin layer formed on the side of the lens surface at the gathering area is very thin, thereby preventing the generation of weld lines, which could be generated if thick skin layers produced when high-temperature molten resin directly comes into contact with steel material and cooled instantaneously are gathered together. Thus, the appearance of the lens surface is improved, and further the mechanical strength at the gathering area for the lens is also improved.

### BRIEF DESCRIPTION OF THE SEVERAL VIEWS OF THE DRAWINGS

FIG. 1 is a schematic sectional view showing an embodiment of a molding die for molding a lens of a vehicular lamp according to the present invention.

FIG. 2 is a diagram showing schematically the flow of molten resin in a die cavity of the die of FIG. 1.

FIG. 3 is a schematic enlarged sectional view showing major portions of another example of the molding die.

FIG. 4 is a schematic perspective view showing an example of a lens molded using a conventional molding die.

### DETAILED DESCRIPTION OF THE INVENTION

Hereinafter, preferred embodiments of a manufacturing method and molding die for a lens of a vehicular lamp according to the present invention will be described.

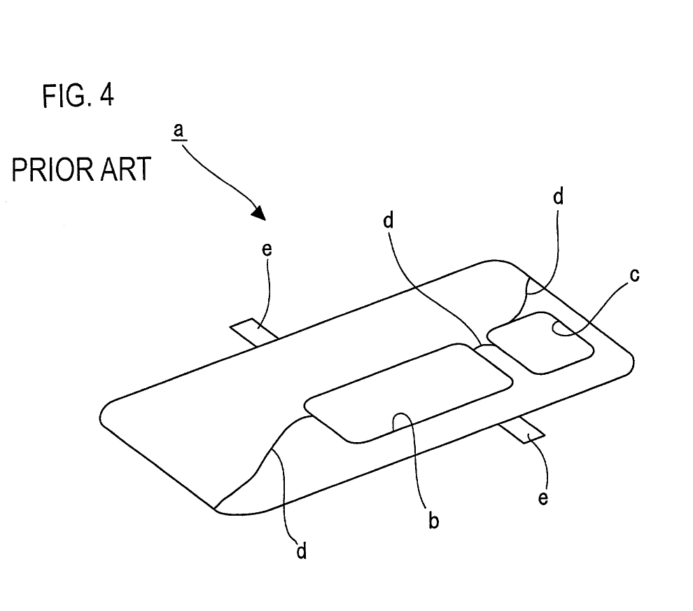

When a lens a of a vehicular lamp as shown in FIG. 4 is molded by injection molding, weld lines d are generated on both the front and rear surfaces of the lens a at the gathering area for molten resin. In FIG. 4, the opening portions b, c are portions to which lenses having a color different from that of the lens a are fitted. With regard to the structures for fitting other lenses, a technique of integral molding employing a so-called multi-color molding method or a technique where a lens molded separately from the lens a is mechanically coupled may be employed.

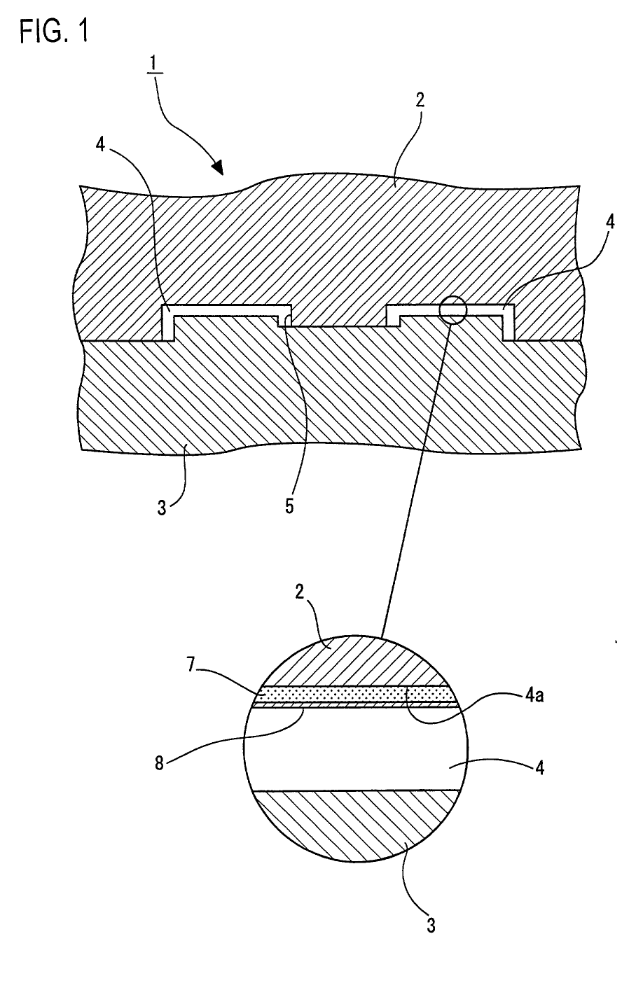

FIG. 1 shows an example of the molding die 1 constructed according to the present invention.

A cavity 4 is formed by clamping a fixed template 2 and a movable template 3 in a molding die 1. When the lens a having the opening portions b, c shown in FIG. 4 is molded, an island-like block portion 5 is formed in the cavity 4.

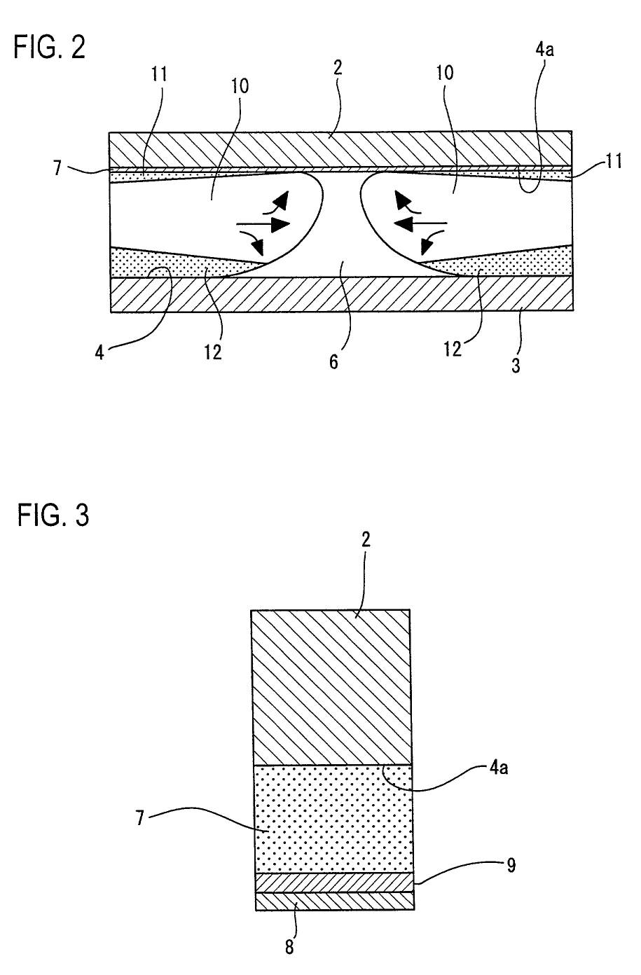

A heat insulating layer 7 is formed on a cavity face 4a on the side of the lens surface at a portion (gathering area) 6 (refer to FIG. 2) where molten resin, which is injected into the above-mentioned cavity and whose flow is split, gathers together.

The heat insulating layer 7, which is provided for increasing the temperature of the cavity face so as to retard cooling in the vicinity of a contact interface between the molten resin and the cavity face by using heat energy of the molten resin itself, is made of a material having a heat conductivity lower than that of metal material of the template, such as a high polymer or ceramics. The heat insulating layer 7 comes into contact with molten resin whose temperature is 200° C. or higher at the time of injection. The temperature of the heat insulating layer 7 becomes room temperature after cooling. Therefore, heat resistance and cold-heat cycle resistance are required. Further, the heat insulating layer 7 needs to have durability so that it can be used repeatedly, and adhesion strength so that it does not separate from the cavity face 4a easily. Moreover, wear resistance is required.

High polymer materials which satisfy these requirements include, for example, polyimide resin obtained by vapor deposition-polymerizing a pyromellitic anhydride and a diamine, polyamide-imide resin obtained by vapor deposition-polymerizing a trimellitic anhydride and a diamine, polyamide resin obtained by vapor deposition-polymerizing a phthaloyl dichloride and a diamine, and polyurea resin obtained by vapor deposition-polymerizing a diamine and a diisocyanate.

For example, in order to generate a polyimide resin film as the heat insulating layer 7, a pyromellitic anhydride and 4,4′-diaminodiphenylether are evaporated in a vapor deposition-polymerizing chamber at the same time as raw material monomers, thereby vapor deposition-polymerizing them on the surface of the fixed template 2. Then, after the film is deposited to a predetermined thickness, baking is performed in another furnace at 300° C. Thus, the heat insulating layer 7 is formed, which adheres to the surface of the fixed template 2 and which is a polyimide resin film with a uniform thickness. If the heat insulating layer 7 is formed by using polyimide resin, the thickness is preferably 50 μm to 100 μm.

In addition, it is preferable to deposit a mold releasing layer 8 made of metal or ceramics in order to protect the heat insulating layer 7 and to improve the mold releasing property of the molded product (lens). For example, among metal materials suitable for the mold releasing layer are chromium (Cr), chromium nitride (CrN) and tungsten (W). Among ceramics are titanium nitride (TiN), and titanium carbide (TiC), although the metal materials and ceramics suitable for use in practicing the invention are not limited to these specific materials. For forming a thin film as the mold releasing layer, it is possible to employ general thin film forming methods such as a sputtering method, an ion plating method, and a low temperature plasma CVD method.

When the above-mentioned mold releasing layer 8 is formed on the heat insulating layer 7, it is preferable to form, as the mold releasing layer 8 a chromium (Cr)-based or titanium (Ti)-based hard film through an intermediate layer 9 made of chromium (Cr), etc., which adheres well to a polyimide resin (refer to FIG. 3). For example, if chromium (Cr) is applied as the intermediate layer 9 to the heat insulating layer 7 made of polyimide resin film, and a layer of chromium nitride (CrN) is applied as the mold releasing layer to the chromium (Cr) layer, the adherence between the respective layers 7, 8, 9 is good. In addition, chromium nitride (CrN) has excellent durability and wear resistance, and as a result, it is possible to obtain a molding die 1 with excellent durability. Also, it is possible to deposit both the thin film of chromium (Cr) and the thin film of chromium nitride (CrN) by a vapor deposition method. Accordingly, the film deposition step can be performed in the same vapor deposition chamber only by changing atmospheric gas (in the case of chromium, argon gas is used, and in the case of chromium nitride, nitrogen gas is used). Thus, the intermediate layer 9 and the mold releasing layer 8 can be deposited continuously. As a result, the molding die 1 can be manufactured at low cost.

The thickness of the above-mentioned intermediate layer 9 is preferably about 0.2 μm. The thickness of the mold releasing layer 8 is preferably 0.2 μm to 5.0 μm.

If a lens having the same shape as the above-mentioned lens a is molded by injecting molten resin into the cavity 4 in the molding die 1, the weld line (d in FIG. 4), which is conventionally generated on the surface of the lens at a gathering area for the molten resin, is not produced and consequently a lens for a vehicular lamp having excellent appearance and high mechanical strength can be obtained. In other words, in the region where the heat insulating layer 7 is formed, heat is instantaneously stored in the heat insulating layer 7 due to the heat of the molten resin 10. The speed at which the molten resin is cooled is slow in the vicinity of the contact interface between the molten resin 10 and the cavity face 4a. A skin layer 11 formed along the contact interface with the cavity face 4a becomes much thinner than a skin layer 12 (which could result in the formation of a weld line) formed in a region where the heat insulating layer 7 is not formed. Therefore, no weld line appears on the surface of a produced lens.

In the above-mentioned embodiment, the heat insulating layer is formed on only the cavity face on the side of the lens surface at the gathering area for the molten resin. However, the heat insulating layer may be formed entirely on the cavity face on the side of the lens surface. Consequently, the transfer property is improved over the entire lens surface and a lens surface closely conforming to design specifications can be obtained.

Although the above-described embodiment relates to an example in which the present invention is applied to a collection die for multi-color molded lens, the scope of application of the present invention is not restricted to collection dies for multi-color molded lens. The present invention can be applied widely to applications where a gathering area for the molten resin is present in the mold die.

The configuration and structure of each part indicated in the above-described embodiment are only examples of embodying the present invention, and the technical scope of the present invention must not be construed as being limitedly thereby.

As evident from the above description, the molding method for a lens of a vehicular lamp according to the present invention is a molding method for a lens of a vehicular lamp, in which a gathering area for molten resin is provided in a cavity that is a flow region of the molten resin to be molded into a lens. The molding method for a lens comprising the steps of injecting molten resin into a cavity in a die, and cooling the molten resin in the cavity. The molding method for a lens is characterized in that a heat insulating layer is formed on a cavity face on the side of lens surface at the gathering area for the molten resin in the die.

Thus, in the manufacturing method for a lens of a vehicular lamp according to the present invention, the molten resin injected into the cavity comes into contact with the heat insulating layer on the side of the lens surface at the gathering area for the molten resin. Thus, instantaneous cooling is prevented, so that the skin layer formed on the side of the lens surface at the gathering area is very thin, thereby preventing the generation of a weld line, which could otherwise be formed if thick skin layers produced when high-temperature molten resin flows which directly come into contact with steel material and are cooled substantially instantaneously are gathered together. For this reason, the appearance of the lens surface is improved, and further the mechanical strength at the gathering area for the lens is also improved.

The molding method for a lens of a vehicular lamp according to the present invention can be realized in various embodiments, and typical examples are as follows:

(1) The above-mentioned molten resin is injected into the die cavity from plural gates.

(2) The block-like obstacle portion is formed in the cavity.

Further, the molding die for a lens of a vehicular lamp according to the present invention is a molding die for a lens of a vehicular lamp including a gathering area for molten resin which is injected into a cavity and which is to be formed into a lens, and is characterized in that a heat insulating layer is formed on a cavity face on the side of the lens surface.

Thus, in the molding die for a lens of a vehicular lamp according to the present invention, the molten resin injected into the cavity comes into contact with the heat insulating layer on the side of the lens surface at the gathering area for the molten resin. Thus, instantaneous cooling is prevented, so that the skin layer formed on the side of the lens surface at the gathering area is very thin, thereby preventing the generation of a weld line, which could otherwise be generated if thick skin layers produced when high-temperature molten resin flows which directly come into contact with steel material and are cooled instantaneously are gathered together. For this reason, the appearance of the lens surface is improved, and further the mechanical strength at the gathering area for the lens is also improved.

The molding die for a lens of a vehicular lamp according to the present invention can be realized in various embodiments and typical examples are as follows:

(1) A plurality of gates for injecting the molten resin into the above-mentioned cavity are provided.

(2) The block-like obstacle portion is formed in the above-mentioned cavity.

It should further be apparent to those skilled in the art that various changes in form and detail of the invention as shown and described above may be made. It is intended that such changes be included within the spirit and scope of the claims appended hereto.

What is claimed is:

1. A method for molding a lens of a vehicular lamp, comprising the steps of:
providing a molding die having a molding cavity in which a gathering area for molten resin is formed in a flow region of molten resin to be molded into a lens;
providing a heat insulating layer on a cavity face on a side of a lens surface at said gathering area for molten resin in said die;
injecting molten resin into said cavity in said die; and
cooling said molten resin in said cavity.

2. The method for molding a lens of a vehicular lamp according to claim 1, wherein said step of injecting molten resin comprises injecting molten resin from multiple gates into said cavity.

3. The method for molding a lens of a vehicular lamp according to claim 1, further comprising the step of disposing a block-like obstacle portion in said cavity.

4. The method for molding a lens of a vehicular lamp according to claim 2, further comprising the step of disposing a block-like obstacle portion in said cavity.

5. The method for molding a lens of a vehicular lamp according to claim 1, wherein said heat insulating layer is made of a material having a heat conductivity lower than that of metal material of the template.

6. The method for molding a lens of a vehicular lamp according to claim 5, wherein said material of said heat insulating layer is one of a high polymer and ceramics.

7. The method for molding a lens of a vehicular lamp according to claim 6, wherein said material of said heat insulating layer is selected from the group consisting of polyimide resin obtained by vapor deposition-polymerizing a pyromellitic anhydride and a diamine, polyamide-imide resin obtained by vapor deposition-polymerizing a trimellitic anhydride and a diamine, polyamide resin obtained by vapor deposition-polymerizing a phthaloyl dichloride and a diamine, and polyurea resin obtained by vapor deposition-polymerizing a diamine and a diisocyanate.

8. The method for molding a lens of a vehicular lamp according to claim 1, wherein said step of providing a heat insulating layer on a cavity face on a side of a lens surface comprises: evaporating a pyromellitic anhydride and 4,4′-diaminodiphenylether in a vapor deposition-polymerizing chamber together with raw material monomers to form a film of predetermined thickness, and baking said film in a furnace.

9. The method for molding a lens of a vehicular lamp of claim 8, wherein said step of baking is performed at a temperature of approximately 300° C.

10. The method for molding a lens of a vehicular lamp of claim 8, wherein said predetermined thickness is in a range of 50 μm to 100 μm.

11. The method for molding a lens of a vehicular lamp of claim 1, further comprising the step of providing a mold releasing layer over said heat insulating layer.

12. The method for molding a lens of a vehicular lamp of claim 1, wherein said mold releasing layer comprises a hard-film layer of one of a chromium-based material and a titanium-based material, and an intermediate layer made of a material which adheres well to a polyimide resin.

13. The method for molding a lens of a vehicular lamp of claim 12, wherein said material of said intermediate layer is chromium.

14. The method for molding a lens of a vehicular lamp of claim 12, wherein the thickness of said mold-releasing layer is in a range of 0.2 μm to 5.0 μm.

15. The method for molding a lens of a vehicular lamp of claim 1, further comprising the steps of forming an intermediate layer over said heat insulating layer and forming a mold releasing layer over said intermediate layer, said heat insulating layer being made of a polyimide resin film, said intermediate layer being made of chromium, and said molding releasing layer being made of chromium nitride.

16. A molding die for a lens of a vehicular lamp, comprising: a die portion having a molding cavity having therein a gathering area for molten resin injected into said cavity and which is to be molded into the lens: and a heat insulating layer formed on a cavity face on a side of a lens surface at said gathering area.

17. The molding die for a lens of a vehicular lamp according to claim 16, further comprising a plurality of injection gates for injecting molten resin into said cavity.

18. The molding die for a lens of a vehicular lamp according to claim 16, further comprising a block-like obstacle portion disposed in said cavity.

19. The molding die for a lens of a vehicular lamp according to claim 16, wherein said heat insulating layer is made of a material having a heat conductivity lower than that of metal material of the template.

20. The molding die for a lens of a vehicular lamp according to claim 16, wherein said material of said heat insulating layer is one of a high polymer and ceramics.
